(19) United States
(12) Patent Application Publication
(10) Pub. No.: US 2006/0270776 A1
(43) Pub. Date: Nov. 30, 2006

(54) A MATTE FINISH COMPOSITION

(75) Inventor: Edward E. Durrant, Paradise, UT (US)

Correspondence Address: STARKWEATHER & ASSOCIATES, 9035 SOUTH 1300 EAST, SUITE 200, SANDY, UT, 84094, US

(73) Assignee: HARRIS RESEARCH, INC., Logan, UT (US)

(21) Appl. No.: 11/419,429

(22) Filed: May 19, 2006

Related U.S. Application Data
(60) Provisional application No. 60/685,550, filed on May 27, 2005.

(51) Int. Cl. B60C 1/00

(52) U.S. Cl. 524/492; 524/591

(57) ABSTRACT

A matte finish composition exhibiting superior qualities of maintaining a matting agent in dispersion without significantly increasing viscosity, which includes a polymer, a water-based solvent, a matting agent and a crosslinking agent. The polymer may include urethane monomers. The matting agent may be silicon dioxide. The matting agent may be a fine dust. The crosslinking agent may include a polyfunctional aziridine such as pentaerythrito-tris-(β-N-aziridinyl propionate).

This application claims benefit of provisional patent application Serial No. 60/685550 filed on 27 May 2005 by Ed Durrant entitled Matte Finish Composition which is herein incorporated by reference.

### BACKGROUND OF THE INVENTION

2. Field of the Invention

The present invention relates to matte finish compositions for covering hardwood floors and other articles. Specifically, the present invention relates to polymer-based finish compositions including particles.

2. Description of the Related Art

It is sometimes desirable to coat or re-coat items such as floors, cabinets, doors (especially wood based items) with a water-based polyurethane product. Further, where a dull or matte finish is desired, one may include a matting agent in the water-based polyurethane product. A typical matting agent is a fine dust. A typical water based polyurethane product is very viscous. It is the increased viscosity that may advantageously keep a matting agent in suspension, preventing the matting agent from collecting in the bottom of a storage unit such as a can or jug. It is also known to mix different matting agents, such as mixing wax with silica, to reduce settling. However, this may reduce the quality of the matting.

However, viscous products are more difficult to apply than thinner products. Therefore, one may choose to thin a water-based polyurethane product to ease application. However, this may result in settling of a matting agent. Where a matting agent has settled, it may be extremely difficult to return the matting agent to suspension. Consequently, the finish may be too glossy or shiny.

Where the matting agent settles in a container of a dissolved polyurethane composition there may be a cement-like composition of matting agent in the bottom that may be extremely difficult to re-suspend. Matting agent may be difficult to properly suspend even from powder form and may take many hours, or even days of mixing using specific methods to ensure proper suspension and proper distribution.

U.S. Pat. No. 5,354,808 to Onwumere et al. discloses ungelled, aqueous dispersions of silane-terminated partially crosslinked polyurethane polymers which are the reaction product of A) an isocyanate-containing prepolymer formed from: (i) a molar excess of organic polyisocyanate sufficient to promote substantially equal access to isocyanate groups; (ii) active hydrogen-containing material; (iii) sterically hindered amines; (iv) emulsifying monomer; B) chain-extending monomer; C) an organic compound having a pKb of at most about 7; and D) a silane coupling agent represented by the general formula ASi(OR²)₃ and present in an amount sufficient to partially crosslink the polyurethane resin but insufficient to gel the dispersion. These dispersions provide advantages over previously known polyurethanes used as surface coatings. The hindered amine allows surface coatings incorporating the polyurethanes to be easily removed by aqueous compositions having pH between about 2 and 5. Methods of making the prepolymers, polymers, and dispersions are also presented.

U.S. Pat. No. 6,790,512 to MacQueen et al. discloses a coated substrate comprising a substrate, a radiation-cured coating or a thermally-cured coating on at least a portion of the substrate, wherein the coating comprises an inherent macroscopic texture. In another embodiment, there is disclosed a pre-cured coating mixture comprising a radiation-curable resin and an initiator, or a thermally-curable resin and thermal initiator, wherein the radiation- or thermally-curable resin and the respective initiator form a pre-cured coating mixture capable of forming a macroscopic texture upon application of the mixture on a substrate. In another embodiment there is disclosed a pre-cured coating mixture comprising a radiation- or thermally-curable resin, an initiator, and texture-producing particles having an effective size to provide a macroscopic texture upon application of the mixture on a substrate. In another embodiment, there is disclosed a coated substrate comprising a substrate and a radiation- or thermally-cured coating on at least a portion of the substrate, wherein the coating comprises an inherent macroscopic texture. In addition, there is disclosed a process for making a coating on a substrate, comprising the steps of distributing a pre-cured coating mixture comprising a radiation-curable resin and an initiator or a thermally-curable resin and thermal initiator over at least a portion of a substrate to form a pre-cured coating having a macroscopic texture, and radiation-curing or thermally curing, respectively, the pre-cured coating to form a radiation-cured or thermally-cured coating having the macroscopic texture.

U.S. Pat. No. 5,830,937 to Shalov et al. discloses coating compositions, wearlayer compositions and surface covering products which utilize wearlayer compositions. The wearlayer compositions are capable of at once exhibiting high initial gloss values and excellent resistance to scuff, stain and gloss loss. Such wearlayer compositions are produced utilizing curable coating compositions which comprise thermoplastic polymer, from about 3% by weight to about 25% by weight of plasticizer for the thermoplastic polymer and at least about 30% by weight of reactive crosslinker. The weight ratio of the thermoplastic polymer to the crosslinker is preferably no greater than about 2:1.

The existing art does not address the problem of the matting agent settling in a finish composition. Further, the existing art does not address the problem of the matting agent settling in a less-viscous finish composition.

What is needed is a matte finish composition that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available matte finish composition. According to one embodiment, the present invention has been developed to provide a matte finish composition with improved dispersion characteristics, including: a water-based solvent; a polymer; a matting agent; and a crosslinking agent.

According to one embodiment, the polymer may include a urethane monomer.

According to another embodiment, the matting agent may be a fine dust. The matting agent may be one selected from the group consisting of: silicon dioxide, alumina, fumed alumina, aluminum oxide, titanium dioxide, zinc oxide, kaolin, talc, calcium carbonate, aluminum silicate, magnesium silicate, calcium silicate, organosilanes, polypropylene, polyethylene, wax, ethylene copolymers, polyamide, polytetraflouroethylane, urea-formaldehyde, and combinations thereof. The matting agent may be silicon dioxide.

In yet another embodiment, the crosslinking agent may be one selected from the group consisting of: carbodiimides, pentaerythrito-tris-(β-N-aziridinyl propionate), tris(N-aziridinyl)phosphine oxide, triethylenemelamine, trimethylolpropane tri-[β-(N-aziridinyl)-propionate, 2,2-bishydroxymethyl butanoltris[3-(1-aziridine) propionate], aziridine-2-methylol acrylate, aziridine-2-methylol methacrylate, N-(2-aziridinyl)methylacrylamide, N-(2-aziridinyl)methylmethacrylamide, 1-(aziridin-2-yl)-2-oxabut-3-ene, 4-(aziridin-2-yl)-but-1-ene, 5-(aziridin-2-yl)-pent-1-ene, oxirane, alcohol, glycydyl ether, glycidyl ester, carboxyl compound, isocyanate, amine, epoxide, vinyl sulfone, amide, allyl compound, and mixtures thereof. The crosslinking agent may be pentaerythrito-tris-(β-N-aziridinyl propionate). The crosslinking agent may be from about 0.5 to about 5 volume percent of the matte finish composition. The crosslinking agent may further include a water-soluble solvent.

According to a further embodiment, the present invention provides a method of suspending a matting agent in a matte finish composition including the step of: adding a crosslinking agent to a composition of a polymer, a matting agent, and a water-based solvent.

In yet a further embodiment, the method may further include the step of mixing the polymer, matting agent, and water-based solvent.

In still a further embodiment, the method may further include the step of adding a water-soluble solvent to the crosslinking agent.

According to yet another embodiment, the polymer may include a urethane monomer.

In still another embodiment, the matting agent may be a fine dust. The matting agent may be one selected from the group consisting of: silicon dioxide, alumina, fumed alumina, aluminum oxide, titanium dioxide, zinc oxide, kaolin, talc, calcium carbonate, aluminum silicate, magnesium silicate, calcium silicate, organosilanes, polypropylene, polyethylene, wax, ethylene copolymers, polyamide, polytetraflouroethylane, urea-formaldehyde, and combinations thereof. The matting agent may be silicon dioxide.

According to a still further embodiment, the crosslinking agent may be selected from the group consisting of: carbodiimides, pentaerythrito-tris-(β-N-aziridinyl propionate), tris(N-aziridinyl)phosphine oxide, triethylenemelamine, trimethylolpropane tri-[β-(N-aziridinyl)-propionate, 2,2-bishydroxymethyl butanoltris[3-(1-aziridine) propionate], aziridine-2-methylol acrylate, aziridine-2-methylol methacrylate, N-(2-aziridinyl)methylacrylamide, N-(2-aziridinyl)methylmethacrylamide, 1-(aziridin-2-yl)-2-oxabut-3-ene, 4-(aziridin-2-yl)-but-1-ene, S-(aziridin-2-yl)-pent-1-ene, oxirane, alcohol, glycydyl ether, glycidyl ester, carboxyl compound, isocyanate, amine, epoxide, vinyl sulfone, amide, allyl compound, and mixtures thereof. The crosslinking agent may be pentaerythrito-tris-(β-N-aziridinyl propionate).

The step of adding the crosslinking agent may include adding sufficient crosslinking agent such that the matte finish composition comprises from about 0.5 to about 5 volume percent of the crosslinking agent.

According to yet a further embodiment, the present invention discloses a method of providing a matte finish on a surface, including the steps of: preparing a matte finish composition by: adding a polymer and a matting agent to a water-based solvent; and adding a crosslinking agent; and applying the matte finish composition to a surface.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

As used herein, “comprising,” including,” “containing, “is,” “are,” “characterized by,” and grammatical equivalents thereof are inclusive or open-ended terms that do not exclude additional, unrecited elements or method steps. “Comprising” is to be interpreted as including the more restrictive terms “consisting of” and “consisting essentially of.”

The present invention provides a matte finish composition with superior abilities in retaining suspension. According to one embodiment, the matte finish composition of the present invention includes a polymer, a matting agent, and a crosslinking agent. It is believed, but not meant to be limiting that the crosslinking agent assists in keeping the matting agent in suspension in the matte finish composition.

The polymer of the present invention may be any known in the art of finish compositions. In one embodiment, the polymer is suitable for a finish on wood. Some suitable polymers for the present invention may include polymers of, for example, urethane monomers, ethylene monomers, propylene monomers, butylene monomers, styrene monomers, acrylic monomers, combinations thereof, and the like. The polymer may be a combination of various monomers making, for example, a copolymer, terpolymer, or the like. In one embodiment, the polymer includes a urethane monomer. In another embodiment, the polymer includes a plurality of urethane monomers.

The polymer may include one or a plurality of strands. In one embodiment, the polymer includes a single-strand. In another embodiment, the polymer may be branched. In yet another embodiment, the polymer may be star-shaped. According to one embodiment, the polymer may be aliphatic. The polymer of the finish composition may be configured to be linked, coupled, or crosslinked. The finish composition may include a plurality of polymer strands (linear or branched) that may be linked, coupled, or crosslinked.

Several polymer compositions are currently available. Some examples of polymer compositions include 93-63-1 Satin, 93-75-2 Satin, 93-260-1 Satin, 93-284-1 Matte and 108-71-1 Matte, all available from Mace Adhesives & Coatings Co., Inc (Dudley, Mass.).

The matte finish composition may also include a matting agent. The matting agent may be any known in the art for producing a matte finish. The matting agent may be a fine dust. The matting agent may be, for example, composed of silicon dioxide, alumina, fumed alumina, aluminum oxide, titanium dioxide, zinc oxide, kaolin. The matting agent may be a mineral such as talc, calcium, mica, and the like. The matting agent may be carbonate, aluminum silicate, magnesium silicate, calcium silicate, organosilanes, polypropylene, polyethylene, wax, ethylene copolymers, polyamide, polyethyl urea resin polytetraflouroethylane, urea-formaldehyde, combinations thereof, and the like.

Matting agents are commercially available. One such commercially available example of a matting agent includes ACEMATT® TS 100 available from Degussa Corporation (Parsippany, N.J.). ACEMATT® TS 100 is composed of silicon dioxide, and has a mean particle size of about 4 μm.

Any suitable amount of matting agent may be used. One of ordinary skill in the art would be able to determine the amount of matting agent. For example, if the desired finish is very shiny, the amount of matting agent used will be small relative to the amount used if the desired finish is very matte.

The matte finish composition also includes a crosslinking agent. It has been observed that including a crosslinking agent in the matte finish composition assists in maintaining the dispersion of the matting agent in the matte finish composition without substantially increasing the viscosity of the composition. Suitable crosslinking agents may include, for example, carbodiimides; polyfunctional arizidines such as pentaerythrito-tris-(β-N-aziridinyl propionate), tris(N-aziridinyl)phosphine oxide, triethylenemelamine, trimethylolpropane tri-[β-(N-aziridinyl)-propionate, 2,2-bishydroxymethyl butanoltris[3-(1-aziridine) propionate], aziridine-2-methylol acrylate, aziridine-2-methylol methacrylate, N-(2-aziridinyl)methylacrylamide, N-(2-aziridinyl)methylmethacrylamide, 1-(aziridin-2-yl)-2-oxabut-3-ene, 4-(aziridin-2-yl)-but-1-ene, 5-(aziridin-2-yl)-pent-1-ene, and the like and their related prepolymeric resins; oxirane; alcohol; glycydyl ether; glycidyl ester; carboxyl compound; isocyanate; amine; epoxide; vinyl sulfone; amide; allyl compound; their prepolymeric resins or a combination thereof.

Crosslinking agents are commercially available. One such commercially available crosslinking agent includes XAMA® 7, a polyfunctinoal aziridine, available from Bayer Material Science, LLC. (Pittsburgh, Pa.).

The crosslinking agent may be present in the matte finish composition in the amount of at least about 0.01 volume percent, or in another embodiment, at least about 0.1 volume percent, or in a further embodiment, at least about 0.3 volume percent, or in a still further embodiment, at least about 0.5 volume percent; and less than about 30 volume percent, or in another embodiment, less than about 15 volume percent, or in a further embodiment, less than about 9 volume percent, or in a still further embodiment, less than about 5 volume percent.

The crosslinking agent may include a solvent, thus making a crosslinking composition. The solvent may be polar or non-polar. The solvent may be water soluble. If the matte finish composition is to be a water-soluble composition, the solvent for the crosslinking agent may be water soluble. Some examples of appropriate solvents for the crosslinking agent may include alcohols; glycol ethers such as ethylene glycol monopropyl ether and ethylene glycol monobutyl ether; combinations thereof; and so forth. In one embodiment, the crosslinking composition includes about 80 volume percent crosslinking agent and 20 volume percent solvent. In one particular embodiment, the solvent includes ethylene glycol monopropyl ether.

In one embodiment, the matte finish composition also includes a solvent. The solvent may be polar or non polar. According to one particular embodiment, the solvent may be water-soluble. According to another embodiment, the solvent may be water. The solvent is configured to at least partially dissolve the polymer. In an embodiment where the solvent is water soluble, and the polymer is a polyurethane, the polymer may be dissolved in the solvent. Dissolving the polymer in a solvent may produce a dissolved polymer composition. This dissolved polymer composition may be from about 10% solids to about 75% solids. In one embodiment, the dissolved polymer composition includes about 30% solids.

The dissolved polymer composition may be further diluted, thus reducing the solids content. The dissolved polymer composition may be diluted to at least 5% solids, or in another embodiment, at least about 10% solids, or in a further embodiment, at least about 15% solids, or in a still further embodiment, at least about 20% solids; and less than about 50% solids, or in another embodiment, less than about 30% solids, or in a further embodiment, less than about 25% solids, or in a still further embodiment, less than about 24% solids. In one particular embodiment, the dissolved polymer composition is diluted to about 22.5% solids. In an embodiment where the solvent is water soluble, the dissolved polymer composition may be diluted with water.

### EXAMPLES

In order to demonstrate the practice of the present invention, the following examples have been prepared. The examples should not, however, be viewed as limiting the scope of the invention. The claims will serve to define the invention.

### Example 1

Example 1 was prepared to illustrate that the crosslinking agent helps to maintain the dispersion of the matting agent in the matte finish composition. The commercially available matte finish composition designated 93-284-1 from Mace Adhesives & Coatings Co., Inc (Dudley, Mass.) was used. This matte finish composition included a urethane polymer, matting agent, and water soluble solvent. To 5 separate bottles (samples 1-5) was added 1 50 mL of the 93-284-1 matte finish composition. Then a crosslinking solution of 80 volume percent XAMA® 7 and 20 volume percent ethylene glycol monopropyl ether was added to samples 2-5 in the amounts listed in Table I. Each sample was then further diluted to 200 mL with water. The samples were allowed to sit for one day, and were then observed. The observations were recorded in Table 1.

TABLE I

| | Matte Finish | Crosslinking | | | |
|---|---|---|---|---|---|
| | Composition | Composition | | | |
| Sample | (mL) | (mL) | Water (mL) | Observations After Mixing | Observations After One Day |
| 1 | 150 | 0 | 50 | precipitate formed | precipitate |
| 2 | 150 | 1 | 49 | no precipitate - good | some precipitation |
| | | | | consistency | |
| 3 | 150 | 2 | 48 | no precipitate - good | some precipitation |
| | | | | consistency | |
| 4 | 150 | 5 | 45 | no precipitate - slightly | minimal precipitation, easily |
| | | | | thickened | dispersed |
| 5 | 150 | 10 | 40 | no precipitate - thickened, | minimal precipitation, easily |
| | | | | slightly lumpy throughout | dispersed |

### Example 2

Example 2 was prepared to illustrate that the matte finish composition of the present invention held the matting agent in dispersion without significantly increasing the vicosity of the matte finish composition. Seven samples (Samples 6-13) were prepared using the commercially available matte finish composition designated 93-284-1 from Mace Adhesives & Coatings Co., Inc (Dudley, Mass.), XAMA® 7 crosslinking agent, and water. The amounts of each component for each sample are listed in Table II. The viscosity of each sample was then tested using a Brookfield DV-I and viscometer. Spindle 502 was used at 100 RPM. The viscosity of each sample is shown in Table II.

TABLE II

| | Matte Finish | | Crosslinking | |
|---|---|---|---|---|
| Sample | Composition | Water | Agent | Viscosity (cP) |
| 6 | 100% | 0% | 0% | 106.0 |
| 7 | 75% | 25% | 0.0% | 42.4 |
| 8 | 75% | 24.5% | 0.5% | 37.6 |
| 9 | 75% | 24.0% | 1.0% | 39.6 |
| 10 | 75% | 22.5% | 2.5% | 40.4 |
| 11 | 75% | 20.0% | 5.0% | 50.0 |
| 12 | 100% | 0% | 0% | 94.0 |

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

It is also envisioned that the matte finish composition may be used to finish a surface. Surfaces such as cabinets, floors, furniture, and the like. The surface to be finished may be composed of a variety of materials such as, for example, wood, glass, polymer, composite, fibers, metal, alloy, glass, wax, mineral, crystal, and so forth.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A matte finish composition with improved dispersion characteristics, comprising:
a solvent;
a polymer;
a matting agent; and
a crosslinking agent.

2. The matte finish composition of claim 1, wherein the solvent is water-based.

3. The matte finish of claim 1, wherein the polymer includes a urethane monomer.

4. The matte finish of claim 1, wherein the matting agent is a fine dust.

5. The matte finish of claim 1, wherein the matting agent is one selected from the group consisting of: silicon dioxide, alumina, fumed alumina, aluminum oxide, titanium dioxide, zinc oxide, kaolin, talc, calcium carbonate, aluminum silicate, magnesium silicate, calcium silicate, organosilanes, polypropylene, polyethylene, wax, ethylene copolymers, polyamide, polytetraflouroethylane, urea-formaldehyde, and combinations thereof.

6. The matte finish of claim 5, wherein the matting agent is silicon dioxide.

7. The matte finish of claim 1, wherein the crosslinking agent is one selected from the group consisting of: carbodiimides, pentaerythrito-tris-(β-N-aziridinyl propionate), tris(N-aziridinyl)phosphine oxide, triethylenemelamine, trimethylolpropane tri-[β-(N-aziridinyl)-propionate, 2,2-bishydroxymethyl butanoltris[3-(1-aziridine) propionate], aziridine-2-methylol acrylate, aziridine-2-methylol methacrylate, N-(2-aziridinyl)methylacrylamide, N-(2-aziridinyl)methylmethacrylamide, 1-(aziridin-2-yl)-2-oxabut-3-ene, 4-(aziridin-2-yl)-but-1-ene, 5-(aziridin-2-yl)-pent-1-ene, oxirane, alcohol, glycydyl ether, glycidyl ester, carboxyl compound, isocyanate, amine, epoxide, vinyl sulfone, amide, allyl compound, and mixtures thereof.

8. The matte finish of claim 7, wherein the crosslinking agent is pentaerythrito-tris-(β-N-aziridinyl propionate).

9. The matte finish of claim 1, wherein the crosslinking agent comprises from about 0.5 to about 5 volume percent of the matte finish composition.

10. The matte finish of claim 1, wherein the crosslinking agent further comprises a water-soluble solvent.

11. A method of enhancing a dispersion characteristic of a matte finish composition comprising the steps of:
adding a crosslinking agent to a composition of a polymer, a matting agent, and a water-based solvent.

12. The method of claim 11, further comprising the step of adding a water-soluble solvent to the crosslinking agent.

13. The method of claim 11, wherein the polymer includes a urethane monomer.

14. The method of claim 11, wherein the matting agent is a fine dust.

15. The method of claim 11, wherein the matting agent is one selected from the group consisting of: silicon dioxide, alumina, fumed alumina, aluminum oxide, titanium dioxide, zinc oxide, kaolin, talc, calcium carbonate, aluminum silicate, magnesium silicate, calcium silicate, organosilanes, polypropylene, polyethylene, wax, ethylene copolymers, polyamide, polytetraflouroethylane, urea-formaldehyde, and combinations thereof.

16. The method of claim 15, wherein the matting agent is silicon dioxide.

17. The method of claim 11, wherein the crosslinking agent is selected from the group consisting of: carbodiimides, pentaerythrito-tris-(β-N-aziridinyl propionate), tris(N-aziridinyl)phosphine oxide, triethylenemelamine, trimethylolpropane tri-[β-(N-aziridinyl)-propionate, 2,2-bishydroxymethyl butanoltris[3-(1-aziridine) proplonate], aziridine-2-methylol acrylate, aziridine-2-methylol methacrylate, N-(2-aziridinyl)methylacrylamide, N-(2-aziridinyl)methylmethacrylamide, 1-(aziridin-2-yl)-2-oxabut-3-ene, 4-(aziridin-2-yl)-but-1-ene, 5-(aziridin-2-yl)-pent-1-ene, oxirane, alcohol, glycydyl ether, glycidyl ester, carboxyl compound, isocyanate, amine, epoxide, vinyl sulfone, amide, allyl compound, and mixtures thereof.

18. The method of claim 17, wherein the crosslinking agent is pentaerythrito-tris-(β-N-aziridinyl propionate).

19. The method of claim 11, wherein the step of adding the crosslinking agent comprises adding sufficient crosslinking agent such that the matte finish composition comprises from about 0.5 to about 5 volume percent of the crosslinking agent.

20. A method of providing a matte finish on a surface, comprising the steps of:
preparing a matte finish composition by:
adding a polymer and a matting agent to a water-based solvent; and
adding a crosslinking agent; and
applying the matte finish composition to a surface.
